(19) United States
(12) Patent Application Publication
(10) Pub. No.: US 2009/0217942 A1
(43) Pub. Date: Sep. 3, 2009

(54) FOUNTAIN HEAD FLUSH

(76) Inventor: TRAVIS SHEPHERD, Godfrey (CA)

Correspondence Address: James Ray & Associates, 2640 Pitcairn Road, Monroeville, PA, 15146, US

(21) Appl. No.: 12/393,113

(22) Filed: Feb. 26, 2009

Related U.S. Application Data
(60) Provisional application No. 61/067,484, filed on Feb. 28, 2008.

(51) Int. Cl. B08B 3/08; B08B 3/04

(52) U.S. Cl. 134/2; 134/150

(57) ABSTRACT

An apparatus for cleaning a drinking fountain head. The apparatus comprises a substantially hollow bottomless container member for holding a cleaning solution and having each of a predetermined height, a predetermined shape and formed of a predetermined material. There is a sealing member disposed on an inside bottom periphery of the substantially hollow bottomless container member for sealing against an upper portion of such drinking fountain for retaining such cleaning solution.

### CROSS REFERENCE TO RELATED APPLICATIONS

This application is closely related to and claims benefit from U.S. Provisional Application Ser. No. 61/067,484 filed Feb. 28, 2008. This application is also closely related to co-pending U.S. patent application Ser. No. ______, filed concurrently herewith. The teaching of such co-pending application is incorporated herewith by reference thereto.

### FIELD OF THE INVENTION

The present invention relates, in general, to a fountain head cleaner and, more particularly, the present invention relates to a fountain head cleaning system which is placed over a water fountain head to provide a hands free method of cleaning a fountain head.

### BACKGROUND OF THE INVENTION

Currently, to clean a drinking fountain head, a homeowner, a school janitor, or maintenance person must hold a container of cleanser over the fountain head in order to remove the deposits that form on the fountain head. Holding the container in this position for an extended period of time can be not only time consuming but also tiring. Without cleaning the germs and calcium deposits that form on the fountain head a person using the fountain can be susceptible to a variety of germs and can also be an agent for the spread of germs.

Thus, it would be advantageous if there were a means for cleaning a fountain head which does not require all of the work that is currently needed to perform this function.

### SUMMARY OF THE INVENTION

In a first aspect the present invention provides an apparatus for cleaning a drinking fountain head. The apparatus comprises a substantially hollow bottomless container member for holding a cleaning solution and having each of a predetermined height, a predetermined shape and formed of a predetermined material. There is a sealing means disposed on an inside bottom periphery of the substantially hollow bottomless container member for sealing against an upper portion of such drinking fountain for retaining such cleaning solution.

In a second aspect the present invention provides a hands-free method of cleaning a drinking fountain head. The method comprising the steps of selecting an apparatus consisting of a substantially hollow bottomless container member and then placing the apparatus over a fountain head of a drinking fountain. There is a step of sealing the apparatus against a top portion of such drinking fountain and ensuring that such apparatus is sealed against such drinking fountain so that liquid is retained in the apparatus. This is followed by a step of filling the substantially hollow bottomless container member with sufficient cleaning solution so as to cover the fountain head. And then soaking the fountain head for a predetermined time, such predetermined time being sufficient to clean such fountain head and remove any deposits built up therein and thereon.

### OBJECTS OF THE INVENTION

It is, therefore, one of the primary objects of the present invention to provide a hands-free apparatus for cleaning a fountain head.

Another object of the present invention is to provide an apparatus in which cleaning solution can be placed so as to clean the fountain head by soaking in such solution.

Yet another object of the present invention is to provide an apparatus with sealing means to keep the cleaning solution within the apparatus.

Still another object of the present invention is to provide a hands-free method of cleaning a fountain head.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a side perspective view of the container according to an embodiment of he invention with a lid member.

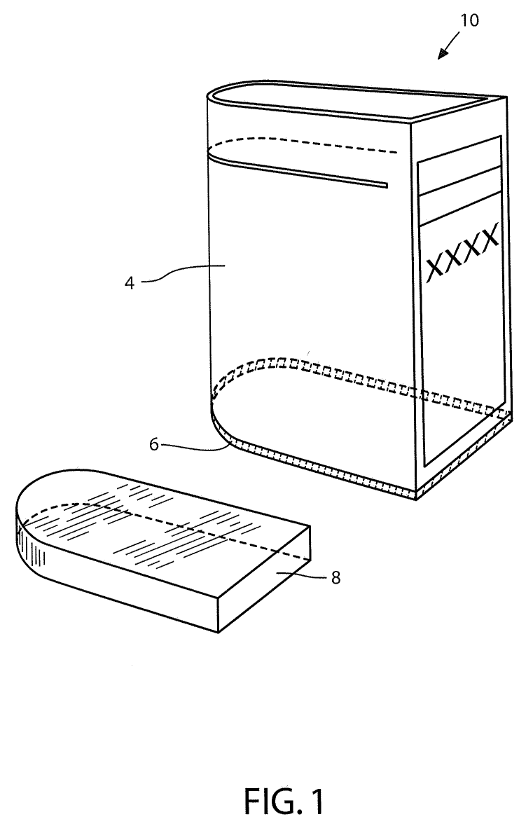

FIG. 2 is a side perspective view of the container in place for cleaning a fountain head.

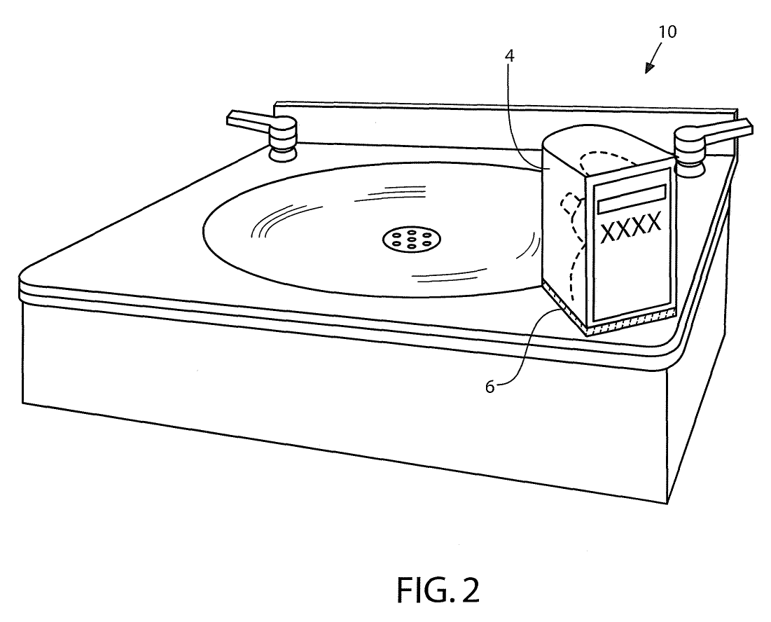

FIG. 3 is a side perspective view of a drinking fountain showing the fountain head.

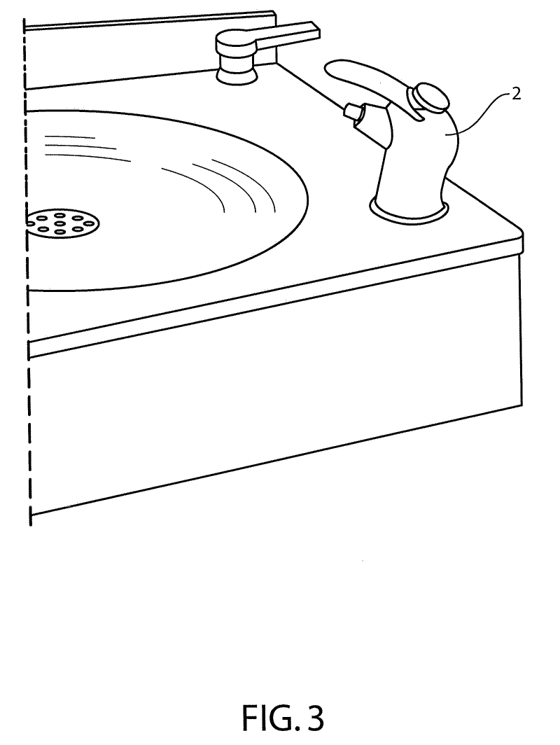

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for cleaning a drinking fountain head 2. The apparatus 10 comprises a substantially hollow bottomless container member 4 for holding a cleaning solution and having each of a predetermined height, a predetermined shape and formed of a predetermined material. There is a sealing means 6 disposed on an inside bottom periphery of the substantially hollow bottomless container member 4 for sealing against an upper portion of such drinking fountain for retaining such cleaning solution.

Such predetermined shape of the substantially hollow bottomless container member is one of oval, circular and rectangular. It is presently preferred that such predetermined shape is substantially rectangular although one end may be curved rather than square.

Such substantially hollow bottomless container member 4 is between about 2¾ and about 3¾ inches wide and between about 4¼ and about 5½ inches long and between about 2¾ and about 3¼ inches high. It is presently preferred that such container member is between about 2⅞ and about 3¼ inches wide and between about 4¾ and about 5¼ inches long and between about 2⅞ and about 3⅛ inches high.

It is also preferred that such apparatus 10 further includes a lid member 8 and even more preferred that such lid member 8 is a snap-on lid 8.

The sealing means is selected from a group including natural rubber, synthetic rubber, silicone rubber and combinations thereof.

In a second aspect the present invention provides a hands-free method of cleaning a drinking fountain head. The method comprising the steps of selecting an apparatus consisting of a substantially hollow bottomless container member and then placing the apparatus over a fountain head of a drinking fountain. There is a step of sealing the apparatus against a top portion of such drinking fountain and ensuring that such apparatus is sealed against such drinking fountain so that liquid is retained in the apparatus. This is followed by a step of filling the substantially hollow bottomless container member with sufficient cleaning solution so as to cover the fountain head. And then soaking the fountain head for a predetermined time, such predetermined time being sufficient to clean such fountain head and remove any deposits built up therein and thereon.

Fountain head flush is a practical product designed to provide consumers with a simple, hands-free way to clean a drinking fountain head. The apparatus comprises a clear acrylic box. There is a rubber seal inside the base of the apparatus for holding the cleaning solution inside. The user simply slides the unit in place over the drinking fountain head and adds the cleaning solution when ready to clean the head. Once in place the unit can remain in place until removed by the consumer after the fountain head is clean.

The apparatus is made of a durable plastic, preferably an acrylic. The reusable apparatus measures approximately 3″ by 5″ which is sufficiently large enough to enclose a fountain head.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for cleaning a drinking fountain head, said apparatus comprising:
(a) a substantially hollow bottomless container member for holding a cleaning solution and having each of a predetermined height, a predetermined shape and formed of a predetermined material; and
(b) a sealing means disposed on an inside bottom periphery of said substantially hollow bottomless container member for sealing against an upper portion of such drinking fountain for retaining such cleaning solution.

2. The apparatus, according to claim 1, wherein said predetermined shape of said substantially hollow bottomless container member is one of oval, circular and rectangular.

3. The apparatus, according to claim 2, wherein said predetermined shape is substantially rectangular.

4. The apparatus, according to claim 3, wherein said substantially hollow bottomless container member is between about 2¾ and about 3¾ inches wide and between about 4¼ and about 5¾ inches long and between about 2¾ and about 3¼ inches high.

5. The apparatus, according to claim 1, wherein said apparatus further includes a lid member.

6. The apparatus, according to claim 5, wherein said lid member is a snap-on lid.

7. The apparatus, according to claim 1, wherein said sealing means is selected from a group including natural rubber, synthetic rubber, silicone rubber and combinations thereof.

8. The apparatus, according to claim 1, wherein said predetermined material is plastic.

9. A hands-free method of cleaning a drinking fountain head said method comprising the steps of:
(a) selecting an apparatus consisting of a substantially hollow bottomless container member;
(b) placing said apparatus over a fountain head of a drinking fountain;
(c) sealing said apparatus against a top portion of such drinking fountain;
(c) ensuring that such apparatus is sealed against such drinking fountain so that liquid is retained in said apparatus;
(d) filling said substantially hollow bottomless container member with sufficient cleaning solution so as to cover said fountain head; and
(e) soaking said fountain head for a predetermined time, such predetermined time being sufficient to clean such fountain head and remove any deposits built up therein and thereon.
